(19) United States
(12) Patent Application Publication
(10) Pub. No.: US 2017/0070116 A1
(43) Pub. Date: Mar. 9, 2017

(54) STEPPING MOTOR

(71) Applicant: Samsung Electronics Co., Ltd, Gyeonggi-do (KR)

(72) Inventors: Jae Kyu Shim, Gyeonggi-do (KR); Bon Min Koo, Seoul (KR); Woo Jong Cho, Gyeonggi-do (KR)

(21) Appl. No.: 15/256,598

(22) Filed: Sep. 4, 2016

(30) Foreign Application Priority Data
Sep. 4, 2015 (KR) 10-2015-0125482

(51) Int. Cl. H02K 3/28; H02K 37/24

(52) U.S. Cl. CPC H02K 3/28; H02K 37/24

(57) ABSTRACT

A stepping motor according to various embodiments includes a rotatable shaft, and two or more engine units that are connected to the shaft, and each of the engine units has a rotor and a stator arranged at a circumference of the rotor.

### CROSS-REFERENCE TO RELATED APPLICATION(S) AND CLAIM OF PRIORITY

The present application is related to and claims the benefit under 35 U.S.C. §119(a) of a Korean patent application filed on Sep. 4, 2015 in the Korean Intellectual Property Office and assigned Serial number 10-2015-0125482, the entire disclosure of which is hereby incorporated by reference.

### TECHNICAL FIELD

The present disclosure relates to a stepping motor that can increase an output torque while maintaining a compact size.

### BACKGROUND

A stepping motor is a motor in which one rotation is divided into a plurality of steps, and may have a very high location precision.

The stepping motor has a rotor and a stator, and N poles and S poles of a plurality of magnets may be alternately arranged on an outer peripheral surface of the rotor to be spaced apart from each other at a specific interval and a driving shaft may be fixed to an axis of the rotor.

The stator has a coil and a yoke, the yoke has an inner yoke and an outer yoke arranged around the rotor, and the inner yoke and the outer yoke may have a plurality of teeth formed in a circumferential direction thereof to have a specific pitch.

The stepping motor may be widely utilized in the fields, such as a lens group driving unit of an interchangeable lens type camera system, which may be easily controlled at a high location precision, and a stepping motor having a large size may be used to a high output torque and a high resolution when the stepping motor is applied to a full frame camera, but a big installation space may be necessary when a stepping motor of a large size is applied.

Further, the number of steps may increase to increase resolution (location precision), an output torque may be lowered as a magnetic flux area becomes narrower if the number of steps increases.

### SUMMARY

To address the above-discussed deficiencies, it is a primary object to provide a stepping motor that can increase an output torque while maintaining a compact size.

The present disclosure also provides a stepping motor that may increase a resolution (location precision) while increasing an output torque thereof.

A stepping motor according to various embodiments includes a rotatable shaft, and two or more engine units that are connected to the shaft, and each of the engine units has a rotor and a stator arranged at a circumference of the rotor.

According to various embodiments, the stator may have an upper stator and a lower stator, each of the upper stator and the lower stator may have an outer yoke and an inner yoke, and each of the outer yoke and the inner yoke may have a plurality of teeth that are formed along a circumferential direction thereof.

According to various embodiments, the teeth of the upper stator and the teeth of the lower stator may be arranged to have a phase difference.

According to various embodiments, the two or more engine units may be installed to be coaxial with the shaft, and the teeth of an engine unit on one side and the teeth of an engine unit on an opposite side may be arranged to have the same phase.

According to various embodiments, the two or more engine units may be installed to be coaxial with the shaft, and the teeth of an engine unit on one side and the teeth of an engine unit on an opposite side may be aligned to have a phase difference.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a stepping motor according to various embodiments of the present disclosure;

FIG. 2 illustrates a stepping motor according to various embodiments of the present disclosure;

FIG. 3 illustrates an embodiment of a teeth arrangement of yokes of the stepping motor of FIG. 1 according to various embodiments of the present disclosure;

FIG. 4 illustrates a relationship between a tooth arrangement of the yokes of the stepping motor of FIG. 3 and an arrangement of welding guides according to various embodiments of the present disclosure;

FIG. 5 illustrates another embodiment of the welding guides of FIG. 4 according to various embodiments of the present disclosure;

FIG. 6 illustrates another embodiment of the tooth arrangement of the stepping motor of FIG. 1 according to various embodiments of the present disclosure;

FIG. 7 illustrates a relationship between a tooth arrangement of the yokes of the stepping motor of FIG. 6 and an arrangement of welding guides according to various embodiments of the present disclosure;

FIG. 8 illustrates a driving circuit of a stepping motor according to various embodiments of the present disclosure;

FIG. 9 illustrates a driving circuit of a stepping motor according to various embodiments of the present disclosure;

FIG. 10 illustrates waveforms of voltages applied to a coil of the stepping motor of FIG. 1 according to various embodiments of the present disclosure; and

FIG. 11 illustrates a stepping motor according to various embodiments of the present disclosure.

Throughout the drawings, it should be noted that like reference numbers are used to depict the same or similar elements, features, and structures.

### DETAILED DESCRIPTION

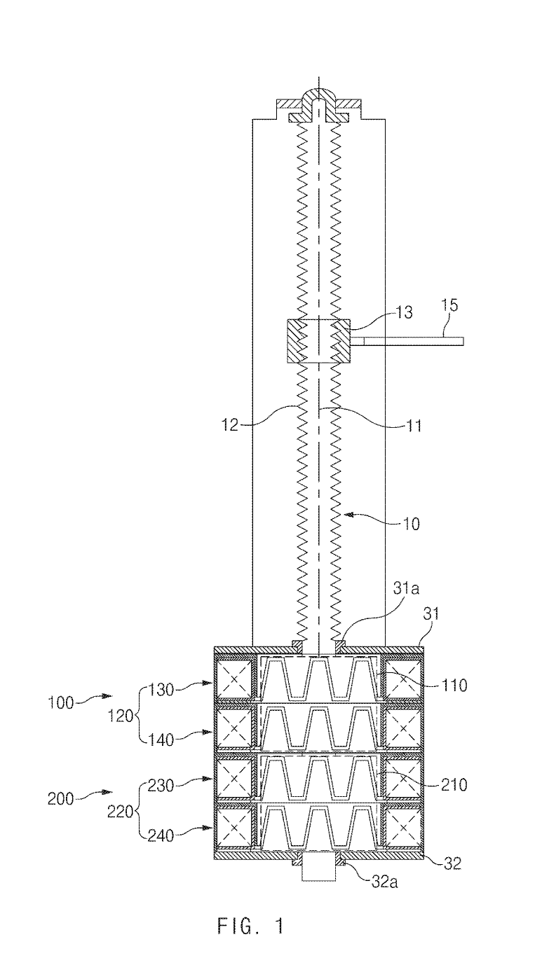

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device.

Hereinafter, various embodiments of the present disclosure will be described with reference to the accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the disclosure disclosed herein, the expressions “have”, “may have”, “include” and “comprise”, or “may include” and “may comprise” used herein indicate existence of corresponding features (for example, elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used as, for example, the expression “suitable for”, “having the capacity to”, “designed to”, “adapted to”, “made to”, or “capable of”. The term “configured to (or set to)” must not mean only “specifically designed to” in hardware. Instead, the expression “a device configured to” may mean that the device is “capable of” operating together with another device or other components. CPU, for example, a “processor configured to (or set to) perform A, B, and C” may mean a dedicated processor (for example, an embedded processor) for performing a corresponding operation or a generic-purpose processor (for example, a central processing unit (CPU) or an application processor) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

Referring to FIG. 1, a stepping motor according to various embodiments of the present disclosure includes a shaft 10, and two or more engine units 100 and 200 that are connected to the shaft 10.

According to various embodiments, the shaft 10 extends along an axis 11, and the shaft 10 has a thread 12 that is formed on an outer peripheral surface thereof at a specific pitch, and a nut member 13 that is coupled to the thread 12 to be movable.

An object 15, such as a lens, that is to be moved may be attached to the nut member 13.

Accordingly, the nut member 13 may be linearly moved along the thread 12 in a direction of the axis 11 as the shaft 10 is rotated by the two or more engine units 100 and 200, and thus the object 15 connected to the nut member 13 also may be linearly moved in the direction of the axis 11.

Further, the shaft 10 may be rotatably supported by one or more brackets 31 and 32, and the brackets 31 and 32 have bearings 31a and 32a that rotatably support an outer peripheral surface of the shaft 10.

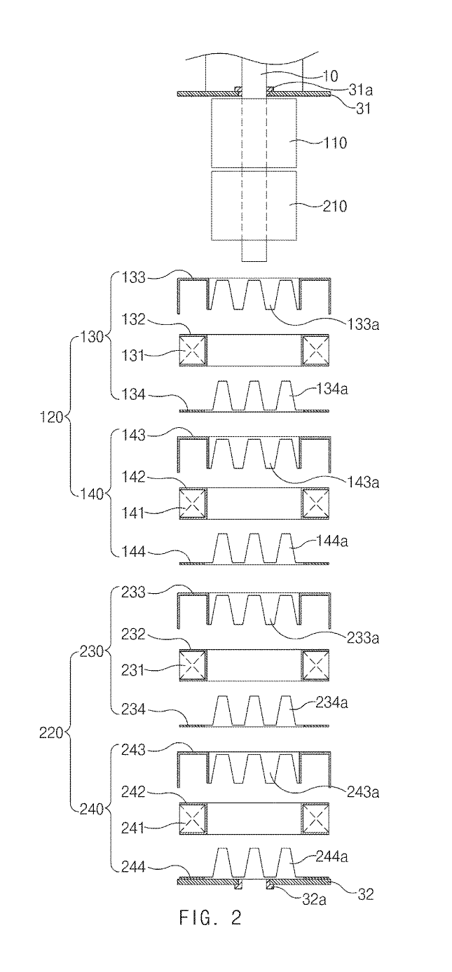

Referring to FIGS. 1 and 2, the two brackets 31 and 32 may be installed to support the two or more engine units 100 and 200, and although the bracket 31 located on the upper side will referred to as a first bracket 31 and the bracket 32 located on the lower side will be referred to as a second bracket 32 for convenience of description, various embodiments of the present disclosure are not limited thereto.

The two or more engine units 100 and 200 may be installed to be coaxial with the shaft 10.

According to various embodiments, as illustrated in FIGS. 1 and 2, the two or more engine units 100 and 200 may be installed adjacent to one end of the shaft 10.

A driver 40 may be connected to the engine units 100 and 200, and a controller 50 for transmitting a driving signal may be connected to the driver 40.

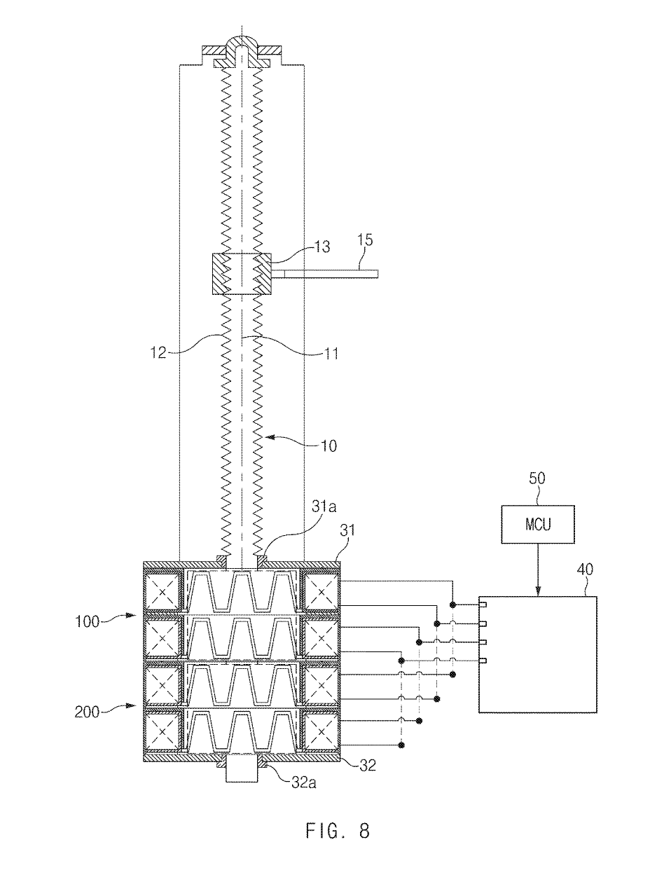

According to various embodiments, as illustrated in FIG. 8, when an output current is sufficient, the driver 40 may be connected in parallel to the plurality of engine units 100 and 200, and thus the controller 50 may control the engine units 100 and 200 in the same manner as in the case of installing a single engine unit.

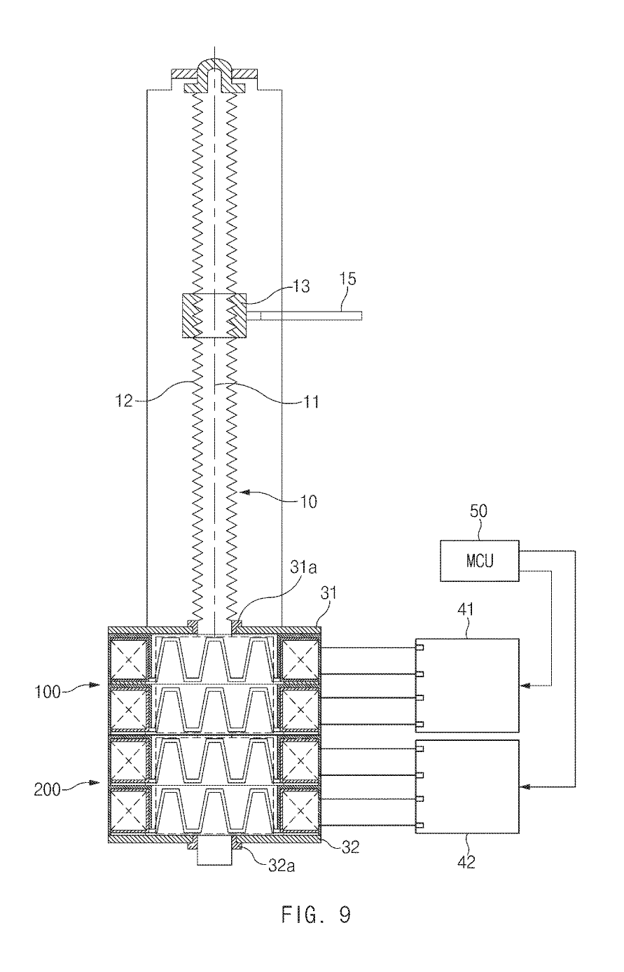

According to another embodiment, as illustrated in FIG. 9, when an output current is not sufficient, two or more drivers 41 and 42 may be individually connected to two or more engine units 100 and 200 and driving signals for driving the drivers 41 and 42 may be transmitted by the controller 50 in the same method, and thus, the controller 50 may control the engine units 100 and 200 in the same method as in the case of driving a single engine unit.

Although the engine unit of the engine units 100 and 200 of FIG. 1, which is located on the upper side, will be referred to as a first engine unit 100 and the engine unit, which is located on the lower side, will be referred to as a second engine unit 200 for convenience of description, various embodiments of the present disclosure are not limited thereto.

<First Engine Unit>

Referring to FIGS. 1 and 2, the first engine unit 100 may include a first rotor 110, and a first stator 120 arranged at a circumference of the first rotor 110.

The first rotor 110 may be installed on one side of the shaft 10, and a plurality of magnets (not illustrated) may be arranged on an outer surface of the first rotor 110 to be spaced apart from each other by a specific interval such that the N poles and S poles of the magnets are alternately arranged.

The first stator 120 may have an upper stator 130 and a lower stator 140 that is arranged below the upper stator 130.

The upper stator 130 may have an upper coil 131 and an upper bobbin 132 on which the upper coil 131 is wound.

The upper bobbin 132 is installed between an outer yoke 133 and an inner yoke 134, and each of the outer yoke 133 and the inner yoke 134 may have a plurality of teeth 133a and 134a that are formed in a circumferential direction thereof. The plurality of teeth 133a and 134a may be arranged to be radially spaced apart from an outer peripheral surface of the first rotor 110.

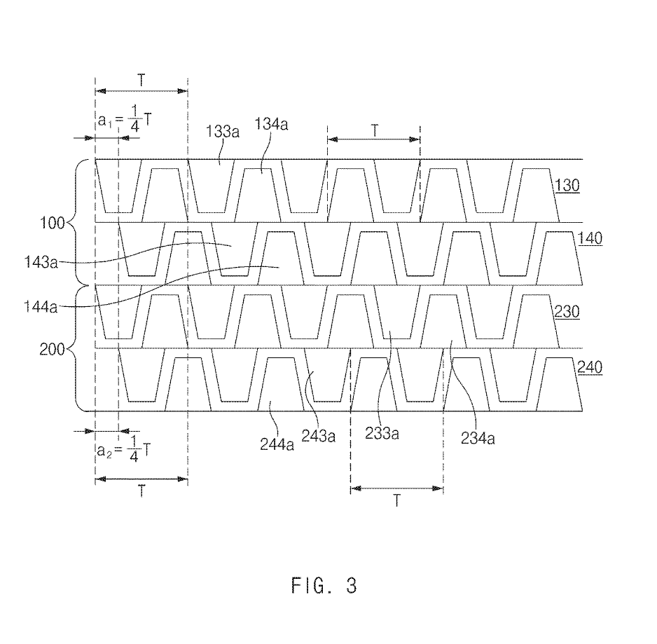

Referring to FIG. 3, the teeth 133a of the outer yoke 133 and the teeth 134a of the inner yoke 134 may have the same size and the same period T, and may be assembled to form a zigzag pattern.

Referring to FIG. 2, the outer yoke 133 may have a cup shape having a plurality of teeth 133a on an inner peripheral surface thereof, and the inner yoke 134 may have a plate shape having a plurality of teeth 134a on an inner peripheral surface thereof.

The lower stator 140 may have a lower coil 141 and a lower bobbin 142 on which the lower coil 141 is wound.

The lower bobbin 142 is installed between an outer yoke 143 and an inner yoke 144, and each of the outer yoke 143 and the inner yoke 144 may have a plurality of teeth 143a and 144a that are formed in a circumferential direction thereof. The plurality of teeth 143a and 144a may be arranged to be radially spaced apart from an outer peripheral surface of the first rotor 110.

The teeth 143a of the outer yoke 143 and the teeth 144a of the inner yoke 144 may have the same size and the same period T as illustrated in FIG. 3, and may be assembled to form a zigzag pattern.

Referring to FIG. 2, the outer yoke 143 may have a cup shape having a plurality of teeth 143a on an inner peripheral surface thereof, and the inner yoke 144 may have a plate shape having a plurality of teeth 144a on an inner peripheral surface thereof.

<First Phase Difference Between Upper Stator and Lower Stator of First Engine Unit>

According to various embodiments, the teeth 133a and 134a of the upper stator 130 and the teeth 143a and 144a of the lower stator 140 have the same size and the same period T.

As illustrated in FIG. 3, the teeth 133a and 134a of the upper stator 130 and the teeth 143a and 144a of the lower stator 140 are arranged to have a first phase difference a₁.

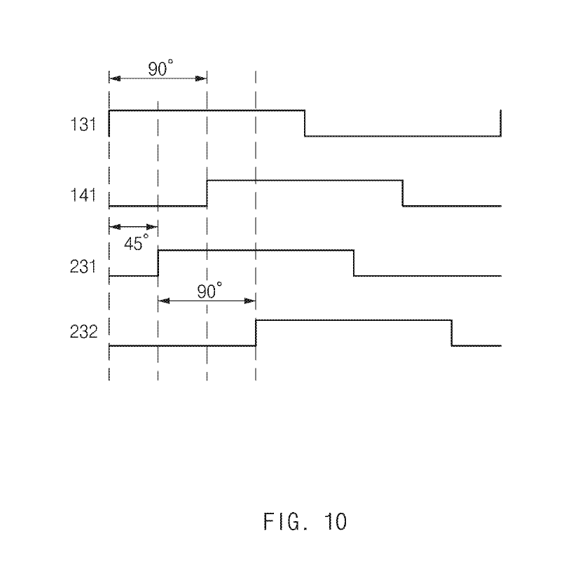

For example, the first phase a₁ is ¼×T for one period T of the teeth 133a, 134b, 143a, and 144a (a₁=¼ T), voltages applied to the upper coil 131 and the lower coil 141 may have a phase difference of 90° as illustrated in FIG. 10.

<First Welding Guides of Upper Stator and Lower Stator of First Engine Unit>

A top surface of the outer yoke 143 of the lower stator 140 and a bottom surface of the inner yoke 134 of the upper stator 130 may be coupled to each other through welding or the like.

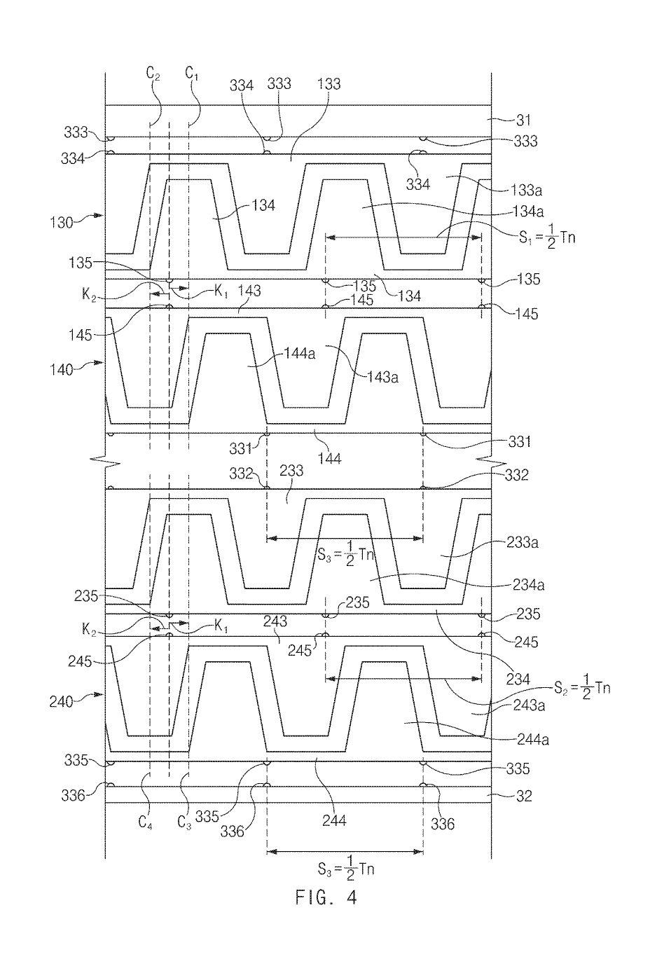

Referring to FIG. 4, the inner yoke 134 of the upper stator 130 and the outer yoke 143 of the lower stator 140 may have a plurality of first welding guides 135 and 145, corresponding ones of which face each other in a vertical direction. Through the plurality of first welding guides 135 and 145, a first phase difference a1 between the teeth 133a and 134a of the upper stator 130 and the teeth 143a and 144a of the lower stator 140 may be precisely established.

According to various embodiments, as illustrated in FIG. 4, the plurality of first welding guides 135 and 145 may include a plurality of upper welding bosses 135 that are formed on the bottom surface of the inner yoke 134 of the upper stator 130, and a plurality of lower welding bosses 145 that are formed on the top surface of the outer yoke 143 of the lower stator 140.

The plurality of upper welding boss 135 may protrude downwards, and the plurality of low welding bosses 145 may protrudes upwards. Accordingly, as the upper welding bosses 135 and the lower welding bosses 145 are welded while being aligned with each other, the upper stator 130 and the lower stator 140 may be coupled to each other in a vertical direction.

The plurality of first welding guides 135 and 145 may be arranged to be spaced apart from each other by a first interval S1, and the first interval S1 of the welding bosses 135 and 145 may be an integer times as large as a half (T/2) of the period of the teeth 133a and 134a as in Equation 1.

S₁=½Tn. [Equation 1]

Referring to FIG. 4, the teeth 133a and 134a of the upper stator 130 and the teeth 143a and 144a of the lower stator 140 are arranged to be misaligned by a half of the first phase difference a₁ in opposite directions with respect to the welding bosses 135 and 145 such that the first phase difference a1 between the upper stator 130 and the lower stator 140 may be precisely established.

For example, as illustrated in FIG. 4, the first phase a₁ between the teeth 133a and 134a of the upper stator 130 and the teeth 143a and 144a of the lower stator 140 is ¼×T, a center line C₁ of the teeth 134a of the inner yoke 134 of the upper stator 130 may be spaced apart from the first welding bosses 135 and 145 by ⅛×T that is a half of the first phase a₁ in a first direction (arrow K₁) and a center line C₂ of the teeth 143a of the outer yoke 143 of the lower stator 140 may be spaced apart from the welding bosses 135 and 145 by ⅛×T that is a half of the first phase a₁ in a second direction (arrow K₂) that is opposite to the first direction.

Because a coupling location of the upper stator 130 and the lower stator 140 may be set through the welding bosses 135 and 145, the teeth 133a and 134a of the upper stator 130 and the teeth 143a and 144a of the lower stator 140 may precisely implement the first phase difference a1, and thus a resolution of the first stator 120 may be secured.

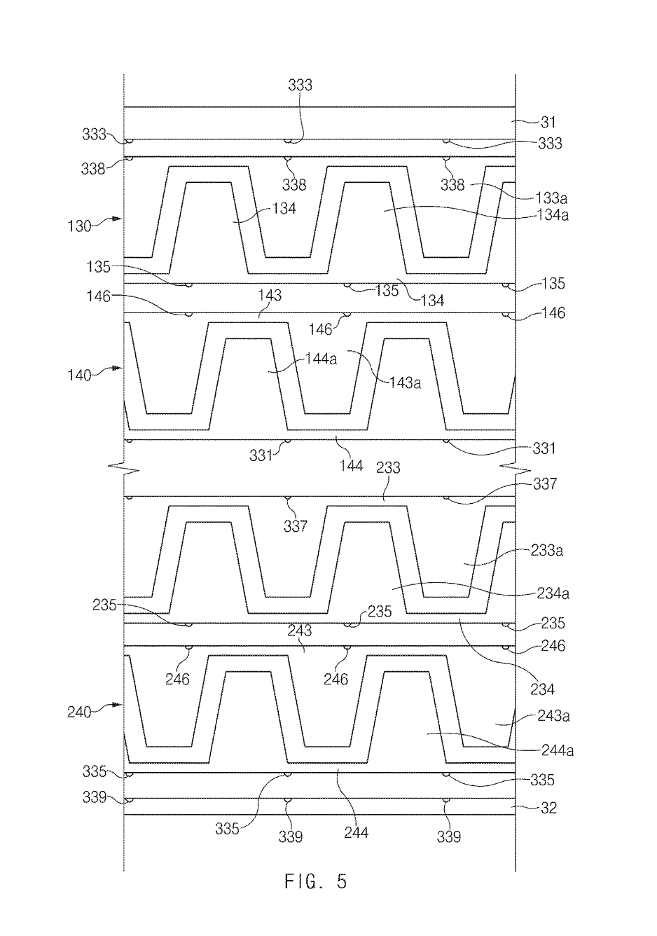

According to another embodiment, as illustrated in FIG. 5, the plurality of first welding guides 135 and 145 may include a plurality of welding bosses 135 that are formed on the bottom surface of the inner yoke 134 of the upper stator 130, and a plurality of lower welding recesses 146 that are formed on the top surface of the outer yoke 143 of the lower stator 140.

Accordingly, as the plurality of welding bosses 135 are inserted into the plurality of welding recesses 146 and are fused to the welding recesses 146 within the welding recesses 146 through welding, the upper stator 130 and the lower stator 140 may be coupled to each other vertically. Further, the welding bosses 135 may be formed to be larger than the welding recesses 146 to be fused firmly.

Further, in various embodiments of the present disclosure, a configuration that is opposite to the structure of FIG. 5 may be possible. For example, a plurality of welding recesses may be formed on the bottom surface of the inner yoke 134 of the upper stator 130, and a plurality of welding bosses may be formed on the top surface of the outer yoke 143 of the lower stator 140.

<Second Engine Unit>

Referring to FIGS. 1 and 2, the second engine unit 200 may include a second rotor 210, and a second stator 220 that is arranged at a circumference of the second rotor 210.

The second rotor 210 may be fixed to a driving shaft 10, and a plurality of magnets (not illustrated) may be arranged on an outer surface of the second rotor 210 to be spaced apart from each other by a specific interval such that the N poles and S poles of the magnets are alternately arranged.

The second stator 220 may have an upper stator 230, and a lower stator 240 that is arranged below the upper stator 230.

The upper stator 230 may have an upper coil 231 and an upper bobbin 231 on which the upper coil 231 is wound.

The upper bobbin 232 is installed between an outer yoke 233 and an inner yoke 234, and each of the outer yoke 233 and the inner yoke 234 may have a plurality of teeth 233a and 234a that are formed in a circumferential direction thereof. The plurality of teeth 233a and 234a may be arranged to be spaced apart from an outer peripheral surface of the second rotor 210 by a specific interval.

Referring to FIG. 3, the teeth 233a of the outer yoke 233 and the teeth 234a of the inner yoke 234 may have the same size and the same period T, and may be assembled to form a zigzag pattern.

Referring to FIG. 2, the outer yoke 233 may have a cup shape having a plurality of teeth 233a on an inner peripheral surface thereof, and the inner yoke 234 may have a plate shape having a plurality of teeth 234a on an inner peripheral surface thereof.

The lower stator 240 may have a lower coil 241 and a lower bobbin 242 on which the lower coil 241 is wound.

The lower bobbin 242 is installed between an outer yoke 243 and an inner yoke 244, and each of the outer yoke 243 and the inner yoke 244 may have a plurality of teeth 243a and 244a that are formed in a circumferential direction thereof. The plurality of teeth 243a and 244a may be arranged to be radially spaced apart from an outer peripheral surface of the second rotor 210.

Referring to FIG. 3, the teeth 243a of the outer yoke 243 and the teeth 244a of the inner yoke 244 may have the same size and the same period T, and may be assembled to form a zigzag pattern.

Referring to FIG. 2, the outer yoke 243 may have a cup shape having a plurality of teeth 243a on an inner peripheral surface thereof, and the inner yoke 244 may have a plate shape having a plurality of teeth 244a on an inner peripheral surface thereof.

<Second Phase Difference Between Upper Stator and Lower Stator of Second Engine Unit>

According to various embodiments, the teeth 233a and 234a of the upper stator 230 and the teeth 243a and 244a of the lower stator 240 have the same size and the same period T as illustrated in FIG. 3.

As illustrated in FIG. 3, the teeth 233a and 234a of the upper stator 230 and the teeth 243a and 244a of the lower stator 240 are arranged to have a second phase difference a₂.

For example, the second phase a₂ is ¼×T for one period T of the teeth 233a, 234a, 243a, and 244a (a₂=¼T), voltages applied to the upper coil 231 and the lower coil 241 may have a phase difference of 90° as illustrated in FIG. 10.

According to various embodiments, the second phase difference a2 of the second engine unit 200 may be the same as the first phase difference a1 of the first engine unit 100.

According to another embodiment, the second phase difference a2 of the second engine unit 200 may be different from the first phase difference a1 of the first engine unit 100.

<Second Welding Guides of Upper Stator and Lower Stator of Second Engine Unit>

A top surface of the outer yoke 243 of the lower stator 240 and a bottom surface of the inner yoke 234 of the upper stator 230 may be coupled to each other through welding or the like.

The plurality of second welding guides 235 and 245 may be formed on the bottom surface of the inner yoke 234 of the upper stator 230 and the top surface of the outer yoke 243 of the lower stator 240 at locations that correspond to each other vertically, and the second phase difference a2 between the teeth 233a and 234a of the upper stator 230 and the teeth 243a and 244a of the lower stator 240 may be precisely established through the plurality of second welding guides 235 and 245.

Referring to FIG. 4, the inner yoke 134 of the upper stator 130 and the outer yoke 143 of the lower stator 140 may have a plurality of first welding guides 135 and 145, corresponding ones of which face each other in a vertical direction. Through the plurality of first welding guides 135 and 145, a first phase difference a1 between the teeth 133a and 134a of the upper stator 130 and the teeth 143a and 144a of the lower stator 140 may be precisely established.

According to various embodiments, the plurality of second welding guides 235 and 245 may include a plurality of upper welding bosses 235 that are formed on the bottom surface of the inner yoke 234 of the upper stator 230, and a plurality of lower welding bosses 245 that are formed on the top surface of the outer yoke 243 of the lower stator 240.

The plurality of upper welding boss 235 may protrude downwards, and the plurality of low welding bosses 245 may protrudes upwards. Accordingly, as the upper welding bosses 235 and the lower welding bosses 245 are fused to each other while being aligned with each other, the upper stator 230 and the lower stator 240 may be coupled to each other in a vertical direction.

The plurality of welding guides 235 and 245 may be arranged to be spaced apart from each other by a second interval S2, and the second interval S2 of the welding bosses 235 and 245 may be an integer times as large as a half (T/2) of the period of the teeth 133a and 134a as in Equation 2.

S₂=½Tn. [Equation 2]

According to various embodiments, the second interval S₂ of the second engine unit 200 may be the same as the first interval S₁ of the first engine unit 100.

According to another embodiment, the second interval S₂ of the second engine unit 200 may be different from the first interval S₁ of the first engine unit 100.

The teeth 233a and 234a of the upper stator 230 and the teeth 243a and 244a of the lower stator 240 are arranged to be misaligned by a half of the second phase difference a_{z} in opposite directions with respect to the second welding guides 235 and 245 such that the second phase difference a_{z} between the upper stator 230 and the lower stator 240 may be precisely established.

For example, the second phase a_{z} between the teeth 233a and 234a of the upper stator 230 and the teeth 243a and 244a of the lower stator 240 is ¼×T, a center line C₃ of the teeth 234a of the inner yoke 234 of the upper stator 230 may be spaced apart from the second welding guides 235 and 245 by a half a₂/2 of the second phase a₂ in a first direction (arrow K₁) and a center line C₄ of the teeth 243a of the outer yoke 243 of the lower stator 240 may be spaced apart from the welding bosses 225 and 245 by a half a₂/2 of the second phase a_{z} in a second direction (arrow K₂) that is opposite to the first direction.

Because a coupling location of the upper stator 230 and the lower stator 240 may be accurately set through the welding bosses 235 and 245, the teeth 233a and 234a of the upper stator 230 and the teeth 243a and 244a of the lower stator 240 may precisely implement the second phase difference a_{z}, and thus the number of steps that is a resolution of the second stator 220 may be secured.

According to another embodiment, as illustrated in FIG. 5, the plurality of second welding guides 235 and 246 may include a plurality of welding bosses 235 that are formed on the bottom surface of the inner yoke 134 of the upper stator 230, and a plurality of lower welding recesses 246 that are formed on the top surface of the outer yoke 243 of the lower stator 240.

Accordingly, as the plurality of welding bosses 235 are inserted into the plurality of welding recesses 246 and are fused to the welding recesses 246 within the welding recesses 246 through welding, the upper stator 230 and the lower stator 240 may be coupled to each other vertically. Further, the welding bosses 235 may be formed to be larger than the welding recesses 246 to be fused firmly.

In various embodiments of the present disclosure, a configuration that is opposite to the structure of FIG. 5 may be possible. For example, a plurality of welding recesses may be formed on the bottom surface of the inner yoke 234 of the upper stator 230, and a plurality of welding bosses may be formed on the top surface of the outer yoke 243 of the lower stator 240.

<Same Phase of First Engine Unit and Second Engine Unit>

Referring to FIGS. 3 to 5, the teeth 133a, 134a, 143a, and 144a of the first engine unit 100 and the teeth 233a, 234a, 243a, and 244a may be arranged to have the same phase.

In this way, according to the present disclosure, an output torque of the stepping motor may become two times higher by adding an output torque by the first engine unit 100 and an output torque by the second engine unit 200.

Further, if three engine units 100 are installed in the shaft 10, an output torque of the stepping motor may become three times by adding output torques of the three engine units, and if four engine units are installed in the shaft 10, an output torque of the stepping motor may become four times by adding outputs of the four engine units.

<Third Welding Guides of First Engine Unit and Second Engine Unit>

Referring to FIG. 4, the first engine unit 100 and the second engine unit 200 may be coupled through welding or the like, and third welding guides 331 and 332 may be formed between the first engine unit 100 and the second engine unit 200.

The lower stator 140 of the first engine unit 100 and the upper stator 230 of the second engine unit 200 may have a plurality of third welding guides 331 and 332, corresponding ones of which face each other vertically, and the first engine unit 100 and the second engine unit 200 may be arranged to have the same phase through the plurality of third welding guides 331 and 332.

According to various embodiments, the plurality of third welding guides 331 and 332 may include a plurality of upper welding bosses 331 that are formed in the lower stator 140 of the first engine unit 100, and a plurality of lower welding bosses 332 that are formed in the upper stator 230 of the second engine unit 200.

The plurality of upper welding boss 331 may protrude downwards, and the plurality of low welding bosses 332 may protrudes upwards. Accordingly, as the upper welding bosses 331 and the lower welding bosses 332 are fused to each other while being aligned with each other, the first engine unit 100 and the second engine unit 200 may be coupled to each other in a vertical direction.

The plurality of first welding guides 331 and 332 may be arranged to be spaced apart from each other by a third interval S3, and the third interval S3 of the welding bosses 335 and 336 may be an integer times as large as a half (T/2) of the period of the teeth 133a, 134a, 143a, 144a, 233a, 234a, 243a, and 244a as in Equation 3.

S₃=½Tn. [Equation 3]

According to various embodiments, as illustrated in FIG. 5, the plurality of third welding guides 331 and 337 may include a plurality of welding bosses 331 that are formed in the lower stator 140 of the first engine unit 100, and a plurality of welding recesses 337 that are formed in the upper stator 230 of the second engine unit 200.

Accordingly, as the plurality of welding bosses 331 are inserted into the plurality of welding recesses 337 and are fused to the welding recesses 337 within the welding recesses 337 through welding, the first engine unit 100 and the second engine unit 200 may be coupled to each other vertically. Further, the welding bosses 331 may be formed to be larger than the welding recesses 337 to be fused more firmly.

Further, in various embodiments of the present disclosure, a configuration that is opposite to the structure of FIG. 5 may be possible. For example, a plurality of welding recesses may be formed in the lower stator 140 of the first engine unit 100, and a plurality of welding bosses may be formed in the upper stator 230 of the second engine unit 200.

<Fourth Welding Guides of First Engine Unit and First Bracket>

Referring to FIG. 4, the first engine unit 100 and the first bracket 31 may be coupled through welding or the like, and the first bracket 31 and the first engine unit 100 may have a plurality of fourth welding guides 333 and 334, corresponding ones of which face each other vertically.

According to various embodiments, the plurality of fourth welding guides 333 and 332 may include a plurality of upper welding bosses 334 that are formed in the upper stator 130 of the first engine unit 100, and a plurality of lower welding bosses 334 that are formed in the first bracket 31.

The plurality of upper welding boss 333 may protrude downwards, and the plurality of low welding bosses 334 may protrudes upwards. Accordingly, as the upper welding bosses 333 and the lower welding bosses 334 are fused to each other while being aligned with each other, the first engine unit 100 and the first bracket 31 may be coupled to each other in a vertical direction.

The plurality of fourth welding guides 333 and 334 may be arranged to be spaced apart from the aforementioned third welding guides 331 and 332 by the same third interval S₃.

According to various embodiments, as illustrated in FIG. 5, the plurality of fourth welding guides 333 and 338 may include a plurality of welding bosses 333 that are formed in the first bracket 31, and a plurality of welding recesses 338 that are formed in the upper stator 130 of the first engine unit 100.

Accordingly, as the plurality of welding bosses 333 are inserted into the plurality of welding recesses 338 and are fused to the welding recesses 338 within the welding recesses 337 through welding, the first bracket 31 and the first engine unit 100 may be coupled to each other vertically. Further, the welding bosses 333 may be formed to be larger than the welding recesses 338 to be fused more firmly.

Further, in various embodiments of the present disclosure, a configuration that is opposite to the structure of FIG. 5 may be possible. For example, a plurality of welding recesses may be formed in the first bracket 31, and a plurality of welding bosses may be formed in the upper stator 130 of the first engine unit 100.

<Fifth Welding Guides of Second Engine Unit and Second Bracket>

Referring to FIG. 4, the second engine unit 200 and the second bracket 32 may be coupled through welding or the like, and the second engine unit 200 and the second bracket 32 may have a plurality of fifth welding guides 335 and 336, corresponding ones of which face each other vertically.

According to various embodiments, the plurality of fifth welding guides 335 and 336 may include a plurality of upper welding bosses 335 that are formed in the lower stator 240 of the second engine unit 200, and a plurality of lower welding bosses 335 that are formed in the second bracket 32.

The plurality of upper welding boss 335 may protrude downwards, and the plurality of low welding bosses 336 may protrudes upwards. Accordingly, as the upper welding bosses 335 and the lower welding bosses 336 are welded while being aligned with each other through welding, the second engine unit 200 and the second bracket 32 may be coupled to each other in a vertical direction.

The plurality of fifth welding guides 335 and 336 may be arranged to be spaced apart from the aforementioned third welding guides 331 and 332 by the same third interval S₃.

According to various embodiments, as illustrated in FIG. 5, the plurality of fifth welding guides 335 and 339 may include a plurality of welding bosses 335 that are formed in the lower stator 240 of the second engine unit 200, and a plurality of welding recesses 339 that are formed in the second bracket 32.

Accordingly, as the plurality of welding bosses 335 are inserted into the plurality of welding recesses 339 and are fused to the welding recesses 338 within the welding recesses 339 through welding, the second engine unit 200 and the second bracket 32 may be coupled to each other vertically. Further, the welding bosses 335 may be formed to be larger than the welding recesses 339 to be fused more firmly.

Further, in various embodiments of the present disclosure, a configuration that is opposite to the structure of FIG. 5 may be possible. For example, a plurality of welding recesses may be formed in the second engine unit 200, and a plurality of welding bosses may be formed in the second bracket 32.

<Third Phase Difference Between First Engine Unit and Second Engine Unit>

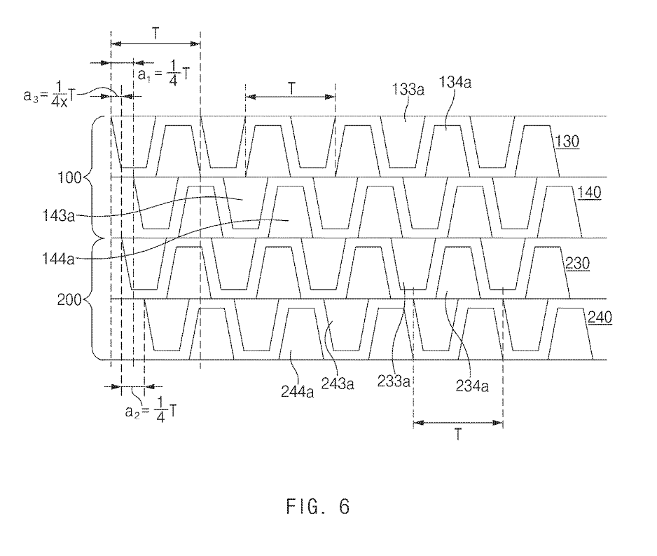

According to another embodiment, as illustrated in FIG. 6, the teeth 133a, 134a, 143a, and 144a of the first engine units 100 and the teeth 233a, 234a, 243a, and 244a of the second engine 200 may be arranged to have a third phase difference a₃.

The third phase difference a3 may be ¼(x) T for one period T of the teeth as in Equation 4.

$${a}_{3} = \frac{1}{4 x} T . \qquad [ Equation 4 ]$$

Here, x represents the number of engine units, and when the number of engine units is 2, the third phase difference a₃ is ⅛×T, when the number of engine units is 3, the third phase difference a₃ is 1/12×T, and the number of engine units is 4, the third phase difference a₃ is 1/16×T.

Further, when the number of engine units is 2, the third phase difference a₃ between the first engine unit 100 and the second engine unit 200 is ⅛×T, voltages applied to the upper coil 131 of the first engine unit 100 and the upper coil 231 of the second engine unit 200 may have a phase difference of 90° as illustrated in FIG. 10.

The adjacent teeth 144a and 233a of the first engine unit 100 and the second engine unit 200 may be arranged to be misaligned by a half a₃/2 of the third phase difference a₃ in opposite directions with respect to the third welding guides 335 and 336, and through this, a third phase difference a₃ between the first engine unit 100 and the second engine unit 200 may be established.

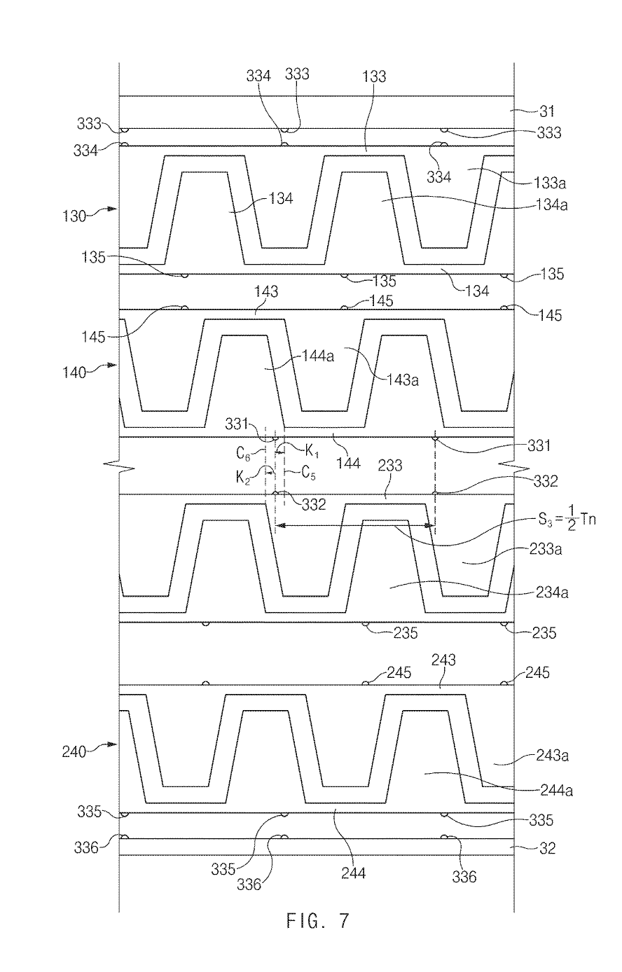

For example, referring to FIG. 7, when the third phase difference a₃ is ⅛×T, an imaginary line C5 that extends perpendicularly to an end of any one tooth 144a of the first engine unit 100 may be spaced apart from the third welding guides 335 and 336 by ⅛×T that is a half of the third phase difference a₃ in the first direction (arrow K₁), and an imaginary line C6 that extends perpendicularly to an end of a tooth 233a of the second engine unit 200 may be spaced apart from the third welding guides 335 and 336 by ⅛×T that is a half of the third phase difference a₃ in the second direction (arrow K₂).

In this way, as the first engine unit 100 and the second engine unit 200 have the third phase difference a3, an output of the stepping motor becomes two times as compared with the case of installing a single engine unit and a resolution of the stepping motor becomes two times by adding the number of steps (resolution) of the first engine unit 100 and the number of steps (resolution) of the second engine unit 200. In addition, if three engine units are coupled to the shaft 10 and the three engine units are arranged to have a third phase difference a3 of 1/12 T, the resolution of the stepping motor may become three times.

Further, because the configurations of the third welding guides 331 and 332, the fourth welding guides 333 and 334, and the fifth welding guides 335 and 336 are the same as or similar to those of the preceding embodiments, a detailed description thereof will be omitted.

According to various embodiments, because two or more engine units 100 and 200 are installed on an outer peripheral surface of the shaft 10 in a row, two or more rotors 110 and 120 may be provided in the shaft 10 in a row as in FIG. 2. Because the two rotors 110 and 120 may be magnetized at the same time while being installed integrally with the shaft 10, the magnetic poles of the two or more rotors 110 and 120 may be precisely established.

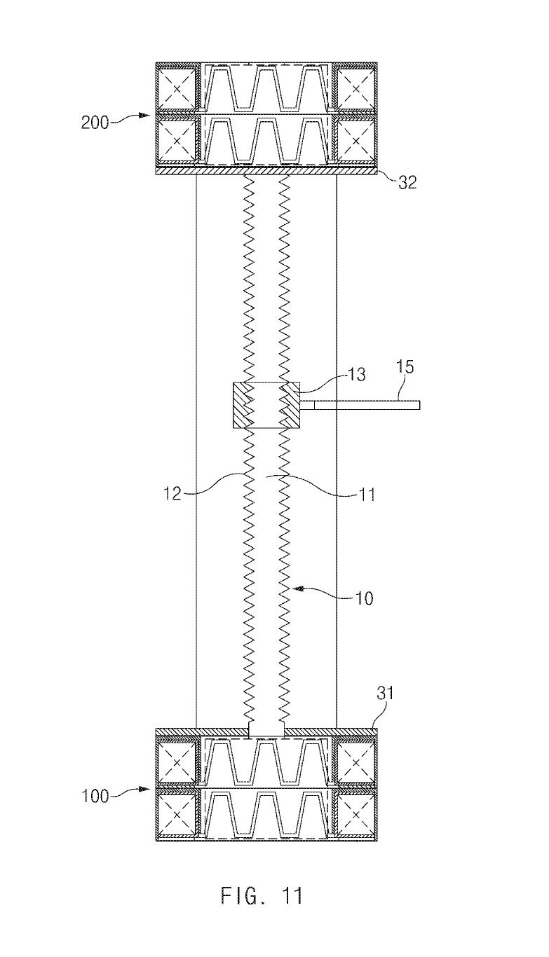

Referring to FIG. 11, in another embodiment of the present disclosure, the first engine unit 100 and the second engine unit 200 may be installed at opposite ends of the shaft 10, respectively.

The first bracket 31 may be arranged at one end of the shaft 10, and the first engine unit 100 may be coupled to the first bracket 31. The first bracket 31 and the first engine unit 100 may be coupled to each other through the aforementioned fourth engine guides 333 and 334 or 333 and 338.

The second bracket 32 may be arranged at an opposite end of the shaft 10, and the second engine unit 200 may be coupled to the second bracket 32. The second bracket 32 and the second engine unit 200 may be coupled to each other through the aforementioned fifth engine guides 335 and 336 or 335 and 339.

Because the remaining configurations thereof are the same as or similar to those of the preceding embodiments, a detailed description thereof will be omitted.

According to various embodiments of the present disclosure, an output torque of a stepping motor can be increased while the stepping motor has a compact size, by connecting two or more engine units to a shaft.

According to various embodiments of the present disclosure, an output torque of a stepping motor can be increased and a resolution (location precision) of the stepping motor can be increased as well by providing a phase difference between the teeth of two or more engine units.

According to various embodiments, a stepping of various layouts may be implemented at low costs because two or more engine units are installed in a shaft.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A stepping motor comprising:
a rotatable shaft; and
two or more engine units that are connected to the shaft,
wherein each of the engine units has a rotor and a stator arranged at a circumference of the rotor.

2. The stepping motor of claim 1, wherein:
the stator has an upper stator and a lower stator,
each of the upper stator and the lower stator has an outer yoke and an inner yoke, and
each of the outer yoke and the inner yoke has a plurality of teeth that are formed along a circumferential direction thereof.

3. The stepping motor of claim 2, wherein the teeth of the upper stator and the teeth of the lower stator are arranged with a phase difference.

4. The stepping motor of claim 3, wherein the upper stator and the lower stator are coupled to each other by a plurality of welding guides.

5. The stepping motor of claim 4, wherein corresponding ones of the plurality of welding guides are formed in the upper stator and the lower stator to face each other.

6. The stepping motor of claim 5, wherein the teeth of the upper stator and the teeth of the lower stator are arranged to be misaligned with each other by a half of the phase difference in opposite directions with respect to the corresponding welding guides.

7. The stepping motor of claim 1, wherein the two or more engine units are installed adjacent to one end of the shaft.

8. The stepping motor of claim 1, wherein the two or more engine units are installed to be coaxial with the shaft, and the teeth of an engine unit on one side and the teeth of an engine unit on an opposite side are arranged to have the same phase.

9. The stepping motor of claim 1, wherein the two or more engine units are installed to be coaxial with the shaft, and the teeth of an engine unit on one side and the teeth of an engine unit on an opposite side are aligned to have a phase difference.

10. The stepping motor of claim 1, wherein the two or more engine units are coupled to each other by a plurality of welding guides.

11. The stepping motor of claim 10, wherein the plurality of welding guides are formed between the two or more engine units.

12. The stepping motor of claim 1, wherein the two or more engine units are divided to be installed at opposite ends of the shaft.

13. The stepping motor of claim 1, wherein the shaft is rotatably installed in one or more brackets.

14. The stepping motor of claim 13, wherein the two or more engine units are supported by the brackets.

15. The stepping motor of claim 1, wherein the shaft comprises a threaded portion on an outer peripheral surface thereof and a nut member is thread-coupled to the threaded portion.

16. The stepping motor of claim 15, further comprising an object that is attached to the nut member.

17. The stepping motor of claim 16, wherein the object is moved linearly with the nut member when the shaft is rotated.

18. The stepping motor of claim 1, further comprising a driver is connected in parallel to the two or more engine units.

19. The stepping motor of claim 1, further comprising two or more drivers are individually connected in parallel to each of the two or more engine units.

20. The stepping motor of claim 19, further comprising a controller configured to control the transmit signals for driving the two or more drivers to control the two or more engine units.
